(19) United States
(12) Patent Application Publication
(10) Pub. No.: US 2026/0269121 A1
(43) Pub. Date: Sep. 10, 2026

(54) QUICK ASSEMBLY COMMON MODE FILTER

(71) Applicant: TAI-TECH ADVANCED ELECTRONICS CO., LTD., Taoyuan City (TW)

(72) Inventors: Li-Chih SU, Taoyuan City (TW); Pao-Lin SHEN, Taoyuan City (TW); Ming-Yen HSIEH, Taoyuan City (TW)

(21) Appl. No.: 19/075,746

(22) Filed: Mar. 10, 2025

(51) Int. Cl. H01F 27/30; H01F 17/04; H01F 27/02; H01F 27/33; H01F 27/36; H01F 38/00

(52) U.S. Cl. CPC H01F 27/306; H01F 17/04; H01F 27/02; H01F 27/33; H01F 27/363; H01F 38/48

(57) ABSTRACT

A quick assembly common mode filter includes a base plate; a plurality of boards, the plurality of boards including a center dividing board and a plurality of separation boards, the center dividing board being arranged at a center of the base plate, the plurality of separation boards being arranged to space from or adjacent to the center dividing board to jointly surround and define a first accommodation zone and a second accommodation zone; and a plurality of inductors, the plurality of inductors being respectively arranged in the first accommodation zone and the second accommodation zone. By arranging the center dividing board and the plurality of separation boards to jointly surround and define the first accommodation zone and the second accommodation zone, the plurality of inductors can be surely set and arranged at correct positions on the base plate.

### BACKGROUND OF THE INVENTION

### a. Technical Field of the Invention

The present invention relates to a common mode filter, and more particularly to a quick assembly common mode filter.

### b. Description of the Prior Art

The present inventor has proposed, in Taiwan Utility Model M569925, an inductor that can be quickly assembled. FIG. 1 of the Utility Model shows that a first coupling portion is provided on one side of a first flange of a first iron core, and a second coupling portion is provided on one side of a second flange of the first iron core, while a first coupled portion is provided on one side of a third flange of a second iron core to correspond to the first coupling portion, and a second coupled portion is provided on one side of a fourth flange of the second iron core to correspond to the second coupling portion. Through complementary recess-and-protrusion engagement between the coupling portions and the coupled portions, the first iron core and the second iron core are combined together.

However, the first iron core and the second iron core of the inductor is combined together only through the complementary recess-and-protrusion engagement between the coupling portions and the coupled portions, and there is on connection made between the inductor and a base plate. If the inductor is not properly fixed and held in position on the base plate, the inductor may get moved or falling. This affects the stability and reliability of a circuit. Or worse, there is no correct contact or connection point on the based plate, and this may cause poor contact between the inductor and the base plate, leading to circuit instability, signal attenuation, or even complete inability to operate.

### SUMMARY OF THE INVENTION

To achieve the above objective, the present invention provides a quick assembly common mode filter, which comprises: a base plate; a plurality of boards, the plurality of boards comprising a center dividing board and a plurality of separation boards, the center dividing board being arranged at a center of the base plate, the plurality of separation boards being arranged to space from or adjacent to the center dividing board to jointly surround and define a first accommodation zone and a second accommodation zone; and a plurality of inductors, the plurality of inductors being respectively arranged in the first accommodation zone and the second accommodation zone.

In the above, the plurality of separation boards comprises two first sub separation boards, the two first sub separation boards being arranged to space from the center dividing board so as to set a distance between the center dividing board and each of the two first sub separation boards.

In the above, the plurality of separation boards comprises two first sub separation boards and two second sub separation boards, the two first sub separation boards being arranged to space from the center dividing board so as to set a distance between the center dividing board and each of the two first sub separation boards, the two second sub separation boards being arranged adjacent to the center dividing board so that each of the two second sub separation boards is adjacent to the center dividing board.

In the above, the plurality of separation boards comprises two second sub separation boards, the two second sub separation boards the two second sub separation boards being arranged adjacent to the center dividing board, so that the two second sub separation boards are each adjacent to the center dividing board.

In the above, the base plate the base plate is provided with a housing, and the housing encloses the plurality of inductors.

By arranging the center dividing board and the plurality of separation boards to jointly surround and define the first accommodation zone and the second accommodation zone, the plurality of inductors can be surely set and arranged at correct positions on the base plate, so that during assembling, the plurality of inductors can be quickly and accurately positioned on the base plate, achieving the best performance and production efficiency, and also, due to accurate positioning on the base plate, operation carried out with automatic equipment can be done in an easy, quick, time-saving, and labor-saving manner.

### BRIEF DESCRIPTION OF THE DRAWINGS

FIG. 1 is a schematic view showing a quick assembly common mode filter according to a first embodiment of the present invention.

FIG. 2 is a schematic view showing inside details of the quick assembly common mode filter according to the first embodiment of the present invention.

FIG. 3 is an exploded view showing the quick assembly common mode filter according to the first embodiment of the present invention.

FIG. 4 is an exploded view showing a quick assembly common mode filter according to a second embodiment of the present invention.

FIG. 5 is a schematic view showing a quick assembly common mode filter according to a third embodiment of the present invention.

FIG. 6 is an exploded view showing the quick assembly common mode filter according to the third embodiment of the present invention.

### DETAILED DESCRIPTION OF THE PREFERRED EMBODIMENTS

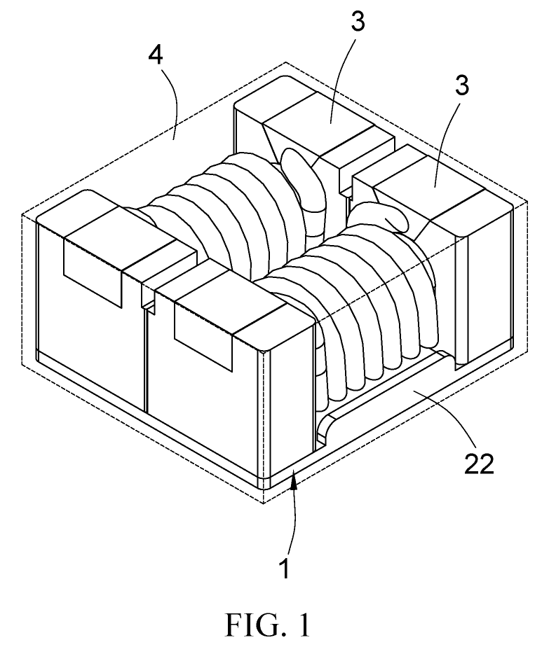

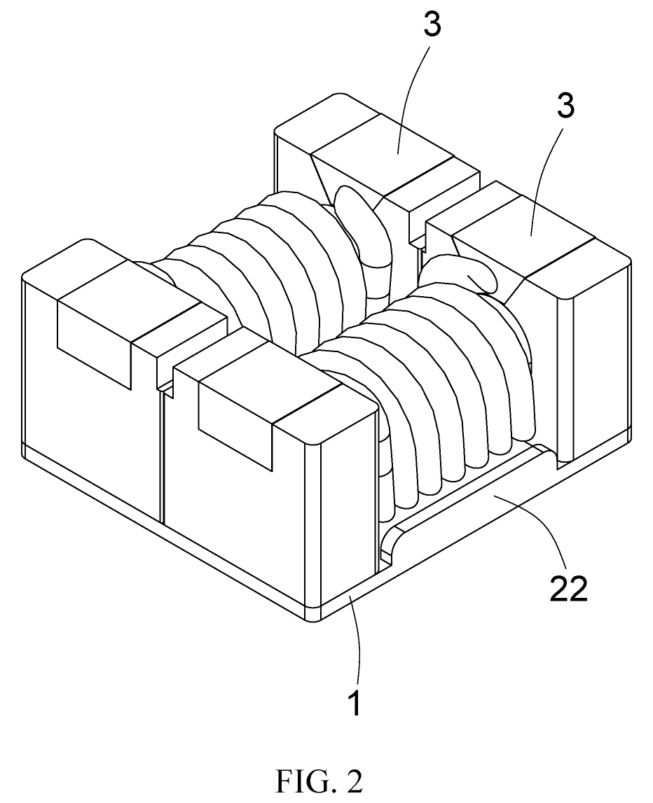

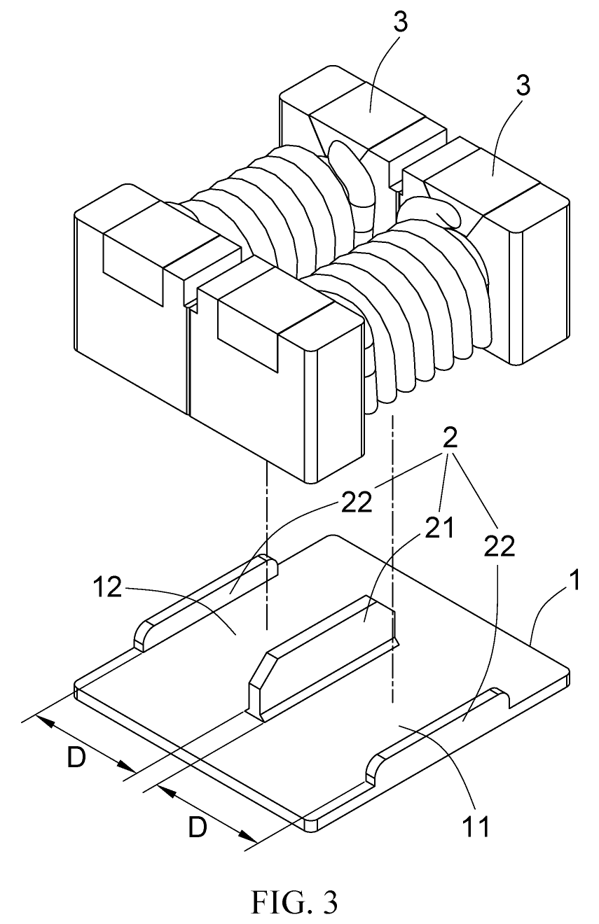

Referring to FIGS. 1, 2, and 3, the present invention provides a quick assembly common mode filter, of which a first embodiment comprises:

a base plate 1, the base plate 1 being used to provide structural supporting;

a plurality of boards 2, the plurality of boards 2 comprising a center dividing board 21 and a plurality of separation boards, the center dividing board 21 being arranged at a center of the base plate 1, the plurality of separation boards being arranged to space from or adjacent to the center dividing board 21, so as to jointly surround and define a first accommodation zone 11 and a second accommodation zone 12,

wherein the plurality of separation boards comprise two first sub separation boards 22, the two first sub separation boards 22 being arranged to space from the center dividing board 21, so as to set a distance D between the center dividing board 21 and each of the two first sub separation boards 22; and

a plurality of inductors 3, the plurality of inductors 3 being respectively arranged in the first accommodation zone 11 and the second accommodation zone 12. As such, the center dividing board 21 and the two first sub separation boards 22 each contact and hold the plurality of inductors 3 in position to thereby prevent the plurality of inductors 3 from moving or falling.

In the common mode filter, the plurality of inductors 3 are arranged by wrapping two windings around two magnetic cores respectively, and the two magnetic cores are connected in series or in parallel to be used in applications where a high filtering performance may be desired.

The base plate 1 is provided with a housing 4, and the housing 4 encloses the plurality of inductors 3. The housing 4 can be made of an electrically conductive material. The conductive material may reflect or absorb external electromagnetic waves to reduce the influences thereof on the equipment and prevent the external electromagnetic interference.

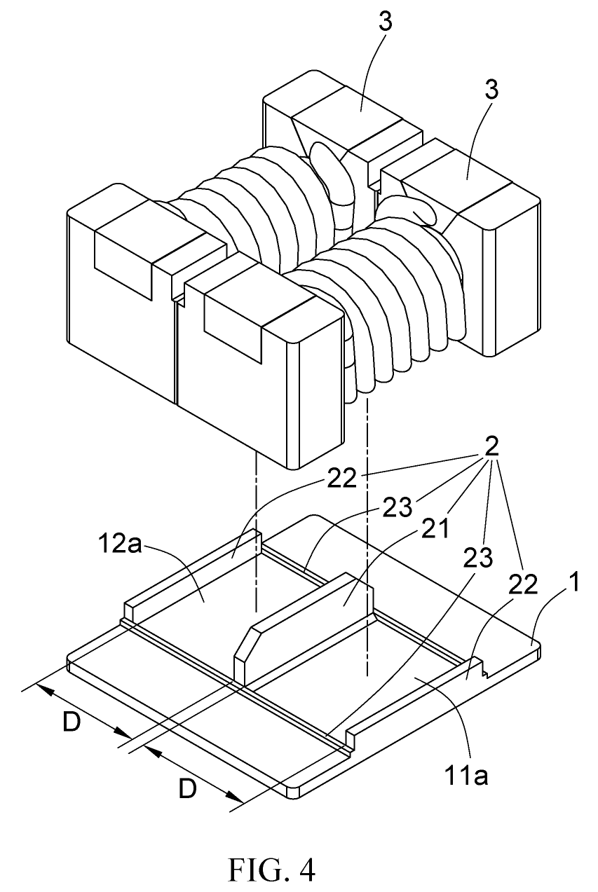

Referring to FIG. 4, a quick assembly common mode filter according to a second embodiment of the present invention is shown, wherein the plurality of separation boards comprise two first sub separation boards 22 and two second sub separation boards 23. The two first sub separation boards 22 are arranged to space from the center dividing board 21, so as to set a distance D between the center dividing board 21 and each of the two first sub separation boards 22. The two second sub separation boards 23 are arranged adjacent to the center dividing board 21, so that the two second sub separation boards 23 are each adjacent to the center dividing board 21, and the center dividing board 21, the two first sub separation boards 22, and the two second sub separation boards 23 jointly surround and define a first accommodation zone 11a and a second accommodation zone 12a. The plurality of inductors 3 are respectively arranged in the first accommodation zone 11a and the second accommodation zone 12a, and the center dividing board 21, the two first sub separation boards 22, and the two second sub separation boards 23 each contact and hold the plurality of inductors 3 in position to thereby prevent the plurality of inductors 3 from moving or falling.

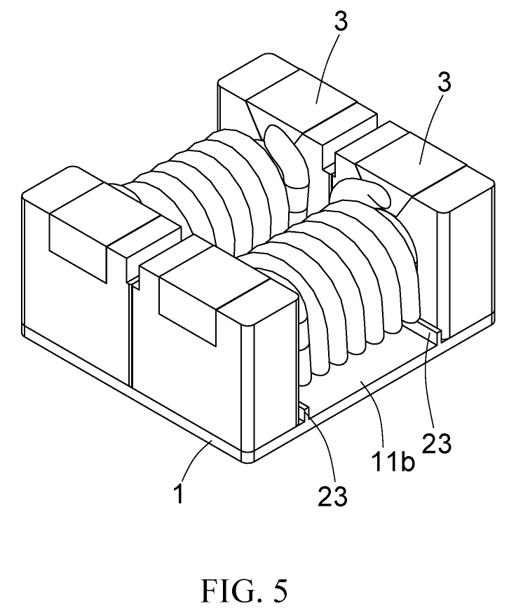

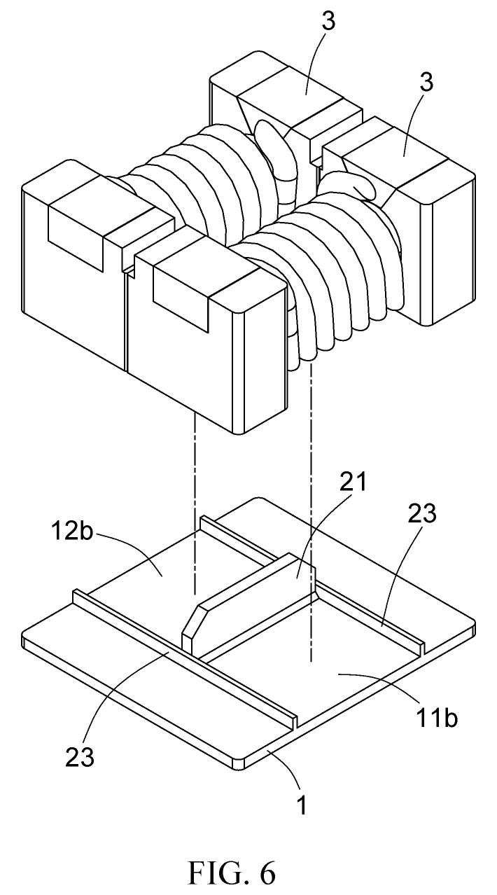

Referring to FIG. 5 and 6, a quick assembly common mode filter according to a third embodiment of the present invention is shown, wherein the plurality of separation boards comprises two second sub separation boards 23. The two second sub separation boards 23 are arranged adjacent to the center dividing board 21, so that the two second sub separation boards 23 are each adjacent to the center dividing board 21, and the center dividing board 21 and the two second sub separation boards 23 jointly surround and define a first accommodation zone 11b and a second accommodation zone 12b. The plurality of inductors 3 are respectively arranged in the first accommodation zone 11b and the second accommodation zone 12b, and the center dividing board 21 and the two second sub separation boards 23 each contact and hold the plurality of inductors 3 in position to thereby prevent the plurality of inductors 3 from moving or falling.

By arranging the center dividing board 21 and the plurality of separation boards to jointly surround and define the first accommodation zone 11 (or 11a, or 11b) and the second accommodation zone 12 (or 12a, or 12b), the plurality of inductors 3 can be surely set and arranged at correct positions on the base plate 1, so that during assembling, the plurality of inductors 3 can be quickly and accurately positioned on the base plate 1, achieving the best performance and production efficiency. Also, due to accurate positioning on the base plate, operation carried out with automatic equipment can be done in an easy, quick, time-saving, and labor-saving manner.

I claim:

1. A quick assembly common mode filter, comprising:
a base plate;
a plurality of boards, the plurality of boards comprising a center dividing board and a plurality of separation boards, the center dividing board being arranged at a center of the base plate, the plurality of separation boards being arranged to space from or adjacent to the center dividing board to jointly surround and define a first accommodation zone and a second accommodation zone; and
a plurality of inductors, the plurality of inductors being respectively arranged in the first accommodation zone and the second accommodation zone.

2. The quick assembly common mode filter according to claim 1, wherein the plurality of separation boards comprises two first sub separation boards, the two first sub separation boards being arranged to space from the center dividing board so as to set a distance between the center dividing board and each of the two first sub separation boards.

3. The quick assembly common mode filter according to claim 1, wherein the plurality of separation boards comprises two first sub separation boards and two second sub separation boards, the two first sub separation boards being arranged to space from the center dividing board so as to set a distance between the center dividing board and each of the two first sub separation boards, the two second sub separation boards being arranged adjacent to the center dividing board so that each of the two second sub separation boards is adjacent to the center dividing board.

4. The quick assembly common mode filter according to claim 1, wherein the plurality of separation boards comprises two second sub separation boards, the two second sub separation boards being arranged adjacent to the center dividing board, so that the two second sub separation boards are each adjacent to the center dividing board.

5. The quick assembly common mode filter according to claim 1, wherein the base plate is provided with a housing, and the housing encloses the plurality of inductors.
